(19) United States
(12) Patent Application Publication
(10) Pub. No.: US 2025/0019948 A1
(43) Pub. Date: Jan. 16, 2025

(54) AERATOR AND SANITARY OUTLET ARRANGEMENT

(71) Applicant: Neoperl GmbH, Müllheim (DE)

(72) Inventor: Georg Stadtler, Müllheim (DE)

(73) Assignee: Neoperl GmbH, Müllheim (DE)

(21) Appl. No.: 18/780,750

(22) Filed: Jul. 23, 2024

Related U.S. Application Data
(63) Continuation of application No. PCT/EP2023/056487, filed on Mar. 14, 2023.

(30) Foreign Application Priority Data
Mar. 16, 2022 (DE) 202022101393.4

(51) Int. Cl. E03C 1/084

(52) U.S. Cl. CPC E03C 1/084

(57) ABSTRACT

A jet regulator (1) that includes, on the outflow side of a splitter unit (2), a plate-shaped carrying structure (43), from which flow obstacles (5) project on both sides into a mixing space (3).

### CROSS-REFERENCE TO RELATED APPLICATIONS

This application is a continuation of PCT/EP2023/056487, filed Mar. 14, 2023, which claims priority from German Patent Application No. 20 2022 101 393.4, filed Mar. 16, 2022, both of which are incorporated herein by reference as if fully set forth.

### TECHNICAL FIELD

The invention relates to a jet regulator having a splitter unit and having, downstream of the splitter unit, flow obstacles extending transversely to a main flow direction, wherein a carrying structure is formed downstream on the splitter unit.

The invention furthermore relates to a sanitary outlet arrangement having a jet regulator as per the previously described type and having an attachment element receiving the jet regulator.

This represents a preferred application in the context of the invention.

### BACKGROUND

The flow obstacles can be arranged, for example in the form of an outlet structure, in a mixing space and/or at a downstream end of a mixing space, for example. It is known to form flow obstacles at an insert part in the mixing space. The carrying structure frequently surrounds the flow obstacles on the outside.

A jet regulator of this type is known for example from U.S. Pat. No. 4,365,755 A.

Jet regulators of this type are known and have proven themselves in practice. The flow obstacles can be arranged such that they bring about good mixing of water flowing in a mean flow direction with sucked-in air, or that they achieve good distribution of partial jets emerging from the splitter unit, for example.

A splitter unit can be characterized, for example, as a functional assembly that brings about decoupling of a flow behavior in the jet regulator, that is to say downstream of the splitter unit, from a flow behavior upstream of the splitter unit. It is thus possible to ensure in a simple manner that a flow behavior in the interior of a jet regulator is independent of the flow behavior upstream or in front of the splitter unit. The decoupling described is frequently achieved by splitting into accelerated individual jets.

Attachment elements have become known by the name “mouthpiece”, for example. Sleeve-type screw sleeves which can be completely screwed into a water outlet of a fitting are also known.

### SUMMARY

The invention is based on the object of simplifying the production of a jet regulator.

To achieve the stated object, one or more of the features disclosed herein are provided according to the invention. In order to achieve the stated object in a jet regulator of the type described in the introductory part, it is thus proposed according to the invention in particular that the carrying structure divides the mixing space into at least two subspaces, that each of the at least two subspaces has a number of the flow obstacles, and that the flow obstacles protrude from the carrying structure. The carrying structure thus carries the flow obstacles. The carrying structure can be molded here to the splitter unit and in particular be connected thereto in one piece. It is advantageous in this case that the jet regulator is formed in one piece at least downstream of the splitter unit. Assembly steps may thus be omitted.

As an alternative or in addition, the features of the second independent claim may be provided according to the invention to achieve the stated object. In particular, in order to achieve the stated problem in a jet regulator of the type described in the introductory part, it is thus proposed according to the invention that due to the connection of the carrying structure to the splitter unit, the flow obstacles are forcibly aligned with positions of holes in the splitter unit for water passing through. The invention has found that a reproducible alignment of the holes, from which the individual jets of the splitter unit emerge, relative to an orientation of the flow obstacles is advantageous for a consistent quality of jet generation over many jet regulators. The forced alignment can eliminate the degree of freedom which normally comes about when insert parts are used as flow obstacles. Additional alignment aids, as are known in the form of guide grooves or guide ribs or other shapes at insert parts, may be omitted. This may also simplify largely automated manufacturing.

It is particularly favorable if the splitter unit is designed as a splitter plate. A resulting planar arrangement of the holes can be aligned particularly easily with the flow obstacles.

It is favorable if an arrangement of the holes is congruent with a shape of the flow obstacles. The holes can thus be easily covered by downstream flow obstacles.

The holes mentioned can be designed in each case as an exit of splitter nozzles of the splitter unit. Flow directions of the individual jets are thus easily prescribable, as a result of which an alignment is realizable even better.

In one configuration, provision may be made for one flow obstacle to be forcibly aligned for each hole in the splitter unit in a manner such that the water passing through the hole is incident on the flow obstacle. Deep penetration of the emerging individual jets into the mixing space is thus avoidable.

It is particularly favorable if the flow obstacle is arranged in an uppermost level of a stack arrangement of flow obstacles. The flow obstacle can thus be arranged particularly closely behind the hole.

In one configuration, provision may be made for the flow obstacles to be aligned parallel to one another at least within one level. Individual rows of holes can thus be covered well by in each case one flow obstacle.

In one configuration, provision may be made for at least one hole in the splitter unit to exist for each flow obstacle in an uppermost level, with the water passing through the hole being incident preferably centrally on the flow obstacle. Flow obstacles without a function may thus be omitted and/or existing flow obstacles are efficiently utilizable for jet splitting and mixing.

In one configuration, provision may be made for the carrying structure to be preferably molded to the splitter unit in one piece. Alignment of the flow obstacles with the holes is thus achievable in one manufacturing step. Additional assembly steps may be omitted.

In one configuration, provision may be made for the carrying structure to be connected via a preferably non-releasable connection that defines the forced alignment. It is advantageous in this case for the carrying structure with the flow obstacles to be combinable with different splitter units, and vice versa. It is furthermore advantageous that the carrying structure with the flow obstacles is manufacturable separately from the splitter unit. This can simplify tool design for injection molding production.

Here, the connection can have a symmetry-breaking interface through which a forced alignment is forced. A form-fitting prescribed forced alignment constitutes a simple means for realizing the advantages according to the invention.

The connection is preferably non-releasable, for example by way of a snap connection. Accidental release of the connection before installation into a use position is thus avoidable.

The mixing space is configured for mixing water with air, in particular for admixing air to form individual jets passing through the splitter unit. The mixing space can be delimited here on the outflow side by an outlet structure and/or flow straighteners. The mixing space can be delimited on the inflow side by the splitter unit. For example, provision may be made here for the mixing space to be designed to be open to the outside. A tool used during injection molding production is thus easy to guide in and to remove after use.

The flow obstacles can be formed on the carrying structure. This enables a one-piece design of the jet regulator at least downstream of the splitter unit.

As an alternative or in addition, a jet regulator having the features of the second coordinate claim may be provided to achieve the stated object. In this solution, it is thus proposed according to the invention for a jet regulator of the type mentioned in the introductory part that the flow obstacles form an outlet structure delimiting the mixing space, that the mixing space is designed to be open to the outside, and that the flow obstacles are molded to the carrying structure. The mixing space can be designed without a circumferential wall and/or to be open on all sides in the circumferential direction. It is thus possible to provide a jet regulator of very simple construction which has essential functions of a more complex jet regulator.

Due to the mixing space being laterally open, injection molding tools are easy to guide in and to remove.

However, in principle it is also conceivable and possible to produce the described jet regulators using an additive method (for example “3D print”).

In one advantageous configuration, provision may be made for the mixing space to be designed without flow obstacles. A geometric complexity of the jet regulator can be reduced in this way. This is particularly favorable in conjunction with an outlet structure which is formed from flow obstacles at the carrying structure.

In one advantageous configuration, provision may be made for the carrying structure to be designed in the shape of a plate. A stabilizing separation of the two subspaces is achievable in this way.

As an alternative or in addition, provision may be made for the carrying structure to be designed to be watertight at least in the region of the flow obstacles. A water flow through the carrying structure is avoidable in this way.

In one advantageous configuration, provision may be made for the carrying structure to be designed in the shape of a pin. It is possible in this way to design rotationally symmetric mixing spaces.

In one advantageous configuration, provision may be made for the carrying structure to extend over a lateral extent of the splitter unit. A liquid-tight closure of the separation of the mixing space is thus possible at least in the region of the flow obstacles.

In one advantageous configuration, provision may be made for the carrying structure to extend from the splitter unit to an outlet structure. It is thus possible to utilize a full installation height of the mixing space for forming flow obstacles. It is furthermore advantageous that an outlet structure can be attached to the splitter unit via the carrying structure. This enables the outlet structure to be connectable in one piece to the splitter unit.

Provision may be made here for the carrying structure to extend at least in each subspace from the splitter unit to an outlet structure. Each subspace is thus utilizable in its full installation height for arranging flow obstacles.

Provision may be made here for the outlet structure to be connected to the carrying structure. A one-piece configuration at least below the splitter unit is achievable in this way.

In one advantageous configuration, provision may be made for the flow obstacles to be designed as parallel extending bars. Simple demolding after the injection molding process is achievable in this way.

In one advantageous configuration, provision may be made for the flow obstacles to each form a free end. An injection molding tool is removable in a simple manner in this way.

In one advantageous configuration, provision may be made for the flow obstacles to each have an end face that simulates a circumferential contour of the splitter unit. A compact basic shape can be achieved in this way. In this way, it is also possible to ensure that the flow obstacles can rest against an inner wall of an attachment element, for example an outlet mouthpiece or a screw sleeve, wherein the attachment element brings a circumferential contour of the splitter unit to the height of the mixing space. It is possible in this manner to achieve in a simple way insertion of the jet regulator into a receiving space of the attachment element.

In one advantageous configuration, provision may be made for a circumferential contour, for example the previously mentioned circumferential contour, of the splitter unit and/or a contour, for example the previously mentioned contour, of an outlet structure, for example the previously mentioned outlet structure, to be round. A geometric compatibility with a fitting having a round basic shape can be provided in a simple manner in this way.

In one advantageous configuration, provision may be made for the flow obstacles at the lateral ends of the carrying structure to be shorter than in a center of the carrying structure. Demoldability of the flow obstacles and a round outer contour can in this way be achieved at the same time in a simple manner.

As an alternative or in addition, provision may be made for a length of the flow obstacles to increase from a lateral end of the carrying structure, for example the previously mentioned lateral end, to a center of the carrying structure, for example the previously mentioned center. A transition from a non-round cross section of the carrying structure to a round outer contour of the jet regulator can easily be achieved in this way.

In one advantageous configuration, provision may be made for the flow obstacles to have a non-increasing cross section in their extent away from the carrying structure. In this way, a constant or decreasing cross section can be achieved, which simplifies demolding during injection molding.

In one advantageous configuration, provision may be made for in each case two adjacent flow obstacles to enclose an intermediate space delimited in the shape of a U. Undercuts at the flow obstacles can be avoided in this way.

In one advantageous configuration, provision may be made for adjacent flow obstacles to be aligned parallel to one another. This can simplify production using injection molding.

In one advantageous configuration, provision may be made for the outlet structure to have completely bounded holes. A lateral delimitation of an emerging water jet can be achieved in this way.

In one advantageous configuration, provision may be made for the outlet structure to have at least one circumferential ring. A ring has proven to be particularly favorable for achieving a pleasing envelope of an emerging water jet.

Provision may be made here for the ring to be designed to match a circumferential contour of the splitter unit. In this way, a cross-sectional shape of a water jet emerging from the outlet structure can be matched to a basic shape of the splitter unit. Since the splitter unit is adaptable in terms of its basic shape to an attachment element, it is thus possible in a simple manner to adapt the cross-sectional shape of the emerging water jet to a basic shape of the attachment element, for example a cylindrical basic shape or a cuboid basic shape.

In one advantageous configuration, provision may be made for the splitter unit to have a perforated plate. In this way, a splitter unit having a particularly simple design can be used. A perforated plate is a component of low complexity during injection molding production, which can be formed as a component which is demoldable on one side. This simplifies one-piece production of the jet regulator.

In one advantageous configuration of potentially independent inventive quality, it is possible in a jet regulator of the type described in the introductory part or in one of the exemplary embodiments described for provision to be made that an aeration channel leading from the outside to the splitter unit is formed in the carrying structure Jet aeration is achievable in this way, without the need for the mixing chamber to have an outer wall.

In one advantageous configuration, provision may be made for a tool contact point for screw-connecting the jet regulator to be formed at the aeration channel. As an alternative or in addition, the tool contact point can be formed at an outlet structure, for example the previously mentioned outlet structure. It is thus possible to introduce torque into the carrying structure and further into the splitter unit. This is particularly favorable if the splitter unit has a thread for screw-connecting to a fitting.

In one advantageous configuration, provision may be made for a tool separation plane to extend along the carrying structure. Demolding along the flow obstacles can be achieved in a simple manner in this way.

In one advantageous configuration, provision may be made for a tool separation plane to extend along the splitter unit. The splitter unit can thus be demolded counter to the main flow direction. It can be ensured in this way that the flow obstacles do not impede demolding of the splitter unit. This simplifies one-piece production of the splitter unit and the carrying structure with flow obstacles.

In one advantageous configuration, provision may be made for a tool separation plane to extend along the outlet structure. The outlet structure can thus be demolded in the main flow direction. It can be ensured in this way that the flow obstacles do not impede demolding of the outlet structure. This simplifies one-piece production of the outlet structure and the carrying structure with flow obstacles.

In one advantageous configuration, provision may be made for the splitter unit to form on the inflow side a preferably circumferential side wall. Attachment of the splitter unit and consequently also of the jet regulator in the main flow path can thus be achieved in a simple manner.

In one advantageous configuration, provision may be made for the splitter unit to be designed in the shape of a cup. In this way, it is possible for the inflowing water at the splitter unit to be captured.

In one advantageous configuration, provision may be made for the flow obstacles to be arranged in at least two groups lying one above the other in the main flow direction. It is possible in this way to form multiple levels in which mixing processes can be brought about in each case.

The flow obstacles of different groups can be of the same type or have different designs from one another.

In one advantageous configuration, provision may be made for flow obstacles which follow one another in the main flow direction to have matching lengths. It is possible in this way to define a uniform outer contour of the mixing space.

In one advantageous configuration, provision may be made for a circumferential contact surface to be formed on the splitter unit, in particular wherein the contact surface delimits the flow obstacles in the lateral direction. In this way, a surface of attack for an attachment element can be formed.

In one advantageous configuration, provision may be made for the splitter unit to have on the inflow side in a perforated region contact elements for (axial) contact with and/or for lateral alignment of a seal ring. An inflow-side seal ring can be positioned in a simple manner in this way.

In one advantageous configuration, provision may be made for the splitter unit to have reinforcement ribs on the outside. Lateral stabilization of the jet regulator can be achieved in this way.

Provision may be made here for free ends of the reinforcement ribs to simulate a contour described by the contact surface. The splitter unit can be fitted into an attachment element in this way.

As an alternative or additionally, in order to achieve the stated object, the features of the coordinate claim, which is directed to a sanitary outlet arrangement, are provided according to the invention. In particular, to achieve the stated object, it is thus proposed according to the invention in a sanitary outlet arrangement of the type described in the introductory part that free ends of the flow obstacles terminate at an inner wall of an attachment element, in particular of the previously mentioned attachment element. Mixing in an entire clear inner region of the inner wall is achievable in this way.

In one advantageous configuration, provision may be made for the attachment element to be designed as a sleeve. It may thus be possible to receive and attach the jet regulator to a fitting in a simple manner.

In the case of a round basic shape, the attachment element can be designed for example as a screw sleeve. This makes it possible to use standardized attachment techniques.

In one advantageous configuration, provision may be made for the attachment element to grip the jet regulator by its splitter unit. It is thus possible to ensure simple and secure suspension of the jet regulator in the main flow path.

In one advantageous configuration, provision may be made for the attachment element to have at least two receptacles for a jet regulator according to the invention, in particular as previously described and/or as claimed in any of the claims which are directed to a jet regulator. Miniaturization due to a parallel arrangement of the jet regulators in the main flow path is achievable in this way. It is possible in this way to form two-dimensional arrangements of jet regulators on an attachment element.

In one advantageous configuration, provision may be made for the attachment element to have at least one aeration window. It is thus possible to realize a supply of air from the outside.

In one advantageous configuration, provision may be made for the outlet structure to be arranged at a distance from the attachment element. An outer ring-shaped component of the emerging water jet which does not interrupt it can be formed in this way.

### BRIEF DESCRIPTION OF THE DRAWINGS

The invention will now be described in more detail on the basis of exemplary embodiments, but is not restricted to the exemplary embodiments. Further exemplary embodiments emerge from combining the features of individual or multiple claims with one another and/or with individual or multiple features of the exemplary embodiment.

In the figures:

FIG. 1 shows a jet regulator according to the invention in a sanitary outlet unit in a three-dimensional oblique view of the inflow side,

FIG. 2 shows the sanitary outlet unit according to FIG. 1 in a three-dimensional oblique view of the outflow side,

FIG. 3 shows an axial section through the sanitary outlet unit according to FIG. 1,

FIG. 4 shows an exploded view of the sanitary outlet unit according to FIG. 1,

FIG. 5 shows the jet regulator of the sanitary outlet unit according to FIG. 1 in a three-dimensional oblique view of the outlet side,

FIG. 6 shows a first side view of the jet regulator according to FIG. 5,

FIG. 7 shows a second side view, rotated by 90° compared to FIG. 6, of the jet regulator according to FIG. 5,

FIG. 8 shows a frontal view of the inflow side of the jet regulator according to FIG. 5,

FIG. 9 shows a frontal view of the outflow side of the jet regulator according to FIG. 5,

FIG. 10 shows a further sanitary outlet unit according to the invention in an axial section,

FIG. 11 shows the sanitary outlet unit according to FIG. 10 in an exploded view,

FIG. 12 shows an axial section (top left), an enlarged detail (right), and a frontal view of the inflow side (bottom left) of the attachment element with installed jet regulators of the sanitary outlet unit according to FIG. 11,

FIG. 13 shows a third sanitary outlet unit according to the invention in a three-dimensional oblique view of the outflow side,

FIG. 14 shows an axial section through the sanitary outlet unit according to FIG. 13,

FIG. 15 shows an exploded view of the sanitary outlet unit according to FIG. 13,

FIG. 16 shows the jet regulator from FIG. 15 in a side view,

FIG. 17 shows the jet regulator from FIG. 15 in a three-dimensional oblique view of the outflow side,

FIG. 18 shows the jet regulator according to FIGS. 16 and 17 in a frontal view of the outflow side,

FIG. 19 shows a fourth sanitary outlet unit according to the invention in a three-dimensional oblique view of the outflow side,

FIG. 20 shows the sanitary outlet unit according to FIG. 19 in a frontal view of the outflow side,

FIG. 21 shows the sanitary outlet unit according to FIG. 19 in a first axial section,

FIG. 22 shows the sanitary outlet unit according to FIG. 19 in a second axial section rotated by 90° compared to FIG. 21,

FIG. 23 shows the jet regulator of the sanitary outlet unit according to FIG. 19 in a three-dimensional oblique view from below,

FIG. 24 shows a further jet regulator according to the invention in a three-dimensional oblique view of the outflow side,

FIG. 25 shows a cross section of the jet regulator according to FIG. 24,

FIG. 26 shows a further axial section through the jet regulator according to FIG. 24 rotated by 90° compared to FIG. 25,

FIG. 27 shows an outlet end of a fitting with an installed jet regulator according to the invention in a longitudinal view,

FIG. 28 shows the arrangement according to FIG. 27 in a cross section, rotated by 90°,

FIG. 29 shows the jet regulator according to FIG. 27 in an oblique view from below of the outflow side,

FIG. 30 shows the jet regulator according to FIG. 29 in an axial section,

FIG. 31 shows the jet regulator according to FIG. 29 in a side view,

FIG. 32 shows the jet regulator according to FIG. 29 in an eccentric axial view,

FIG. 33 shows a further jet regulator according to the invention in a partially (eccentrically) cut-open, three-dimensional oblique view of the outflow side, and

FIG. 34 shows a variant of FIG. 33 in an axial section, and

FIG. 35 shows a variant of FIG. 5 in an axial section.

### DETAILED DESCRIPTION

Matching reference signs will be used below for components and functional units which are functionally and/or structurally of the same type or identical, so that the statements relating to a component or to a functional unit also relate to corresponding details of further exemplary embodiments.

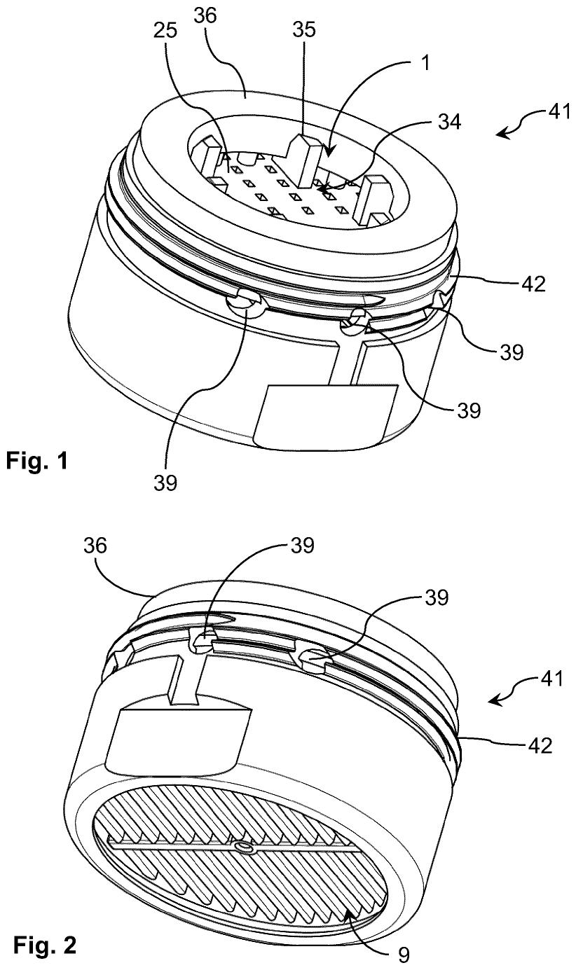

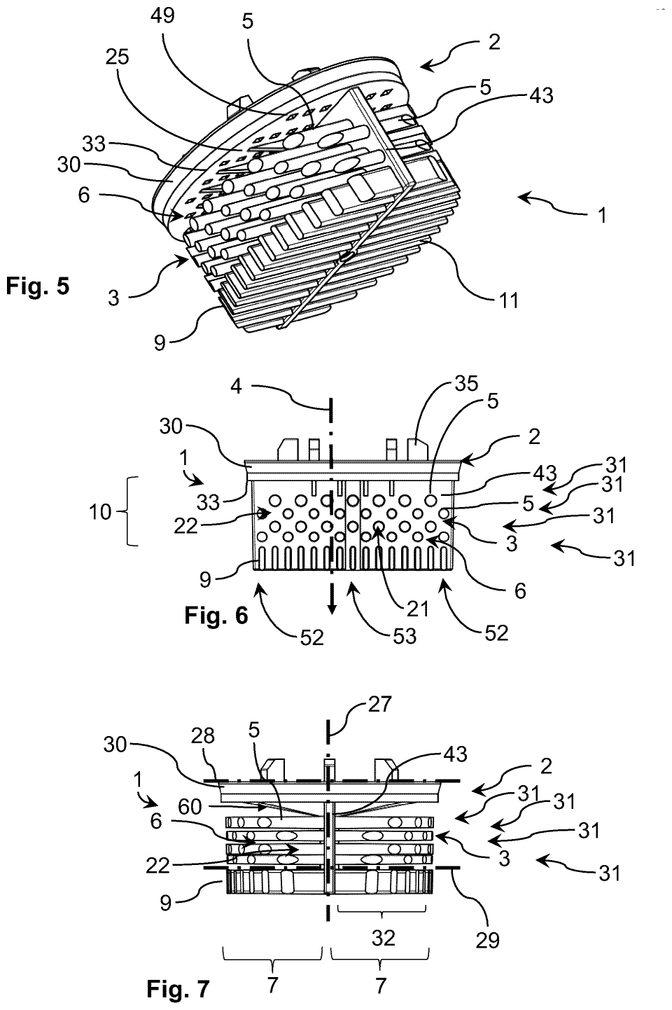

FIGS. 1 to 9 show a first exemplary embodiment according to the invention of a jet regulator 1 of a sanitary outlet unit 41.

The sanitary outlet units 41 shown in each case are here examples of or parts of a respective sanitary outlet arrangement.

The jet regulator 1 comprises, as is generally known, a splitter unit 2.

A mixing space 3 follows the splitter unit 2 in a main flow direction 4.

Flow obstacles 5, which influence a flow behavior in the interior 6 of the jet regulator 1, are formed in the mixing space 3.

The splitter unit 2 has the effect of decoupling the flow behavior in the interior 6 of the jet regulator 1 from the flow behavior upstream of the splitter unit 2, that is to say for example in a fitting 46.

A carrying structure 43, which has the shape of a plate and divides the mixing space 3 into two subspaces 7, is formed in the interior 6 of the jet regulator.

The plate is so large that the carrying structure 43 fills a lateral extent 8 of the splitter unit 2.

Downstream of the mixing space 3 in the main flow direction 4, an outlet structure 9 is arranged.

The splitter unit 2 and the outlet structure 9 consequently delimit the mixing space 3 and define the structural height 10 of the mixing space 3.

It is clear in particular from FIGS. 6 and 7 that the mixing space 3 is designed to be open to the outside.

The carrying structure 43 is here designed to be watertight at least in the region of the flow obstacles 5, with the result that no flow can exist at the height of the flow obstacles 5 between the subspaces 7.

The flow obstacles 5 protrude from the carrying structure 43 and are formed each by a bar 11, whose free end 12 forms a front face 13.

The front faces 13 are adapted in terms of shape to a circumferential contour 14 of the splitter unit 2 such that a reception space 19, on or against which the splitter unit 14 can rest, is in contact with the flow obstacles 5 or is arranged at a defined distance therefrom.

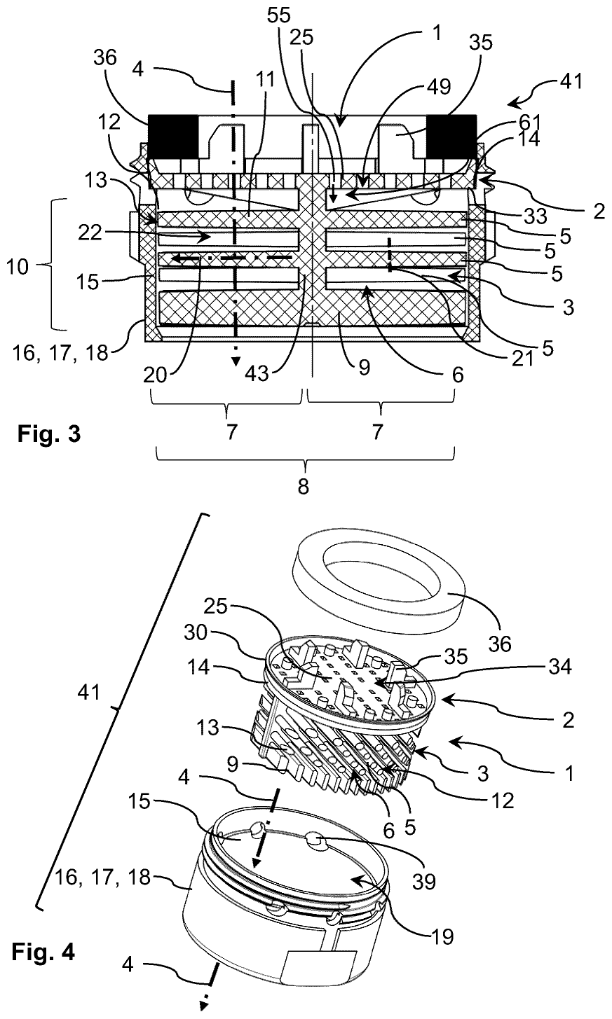

It is clear in FIG. 3 that the flow obstacles 5 extend with their free ends 12 to an inner wall 15 of an attachment element 16.

The attachment element 16 in the example is in the form of a screw sleeve 17 or a mouthpiece 18 and serves for attaching the jet regulator 1 in the outlet of a fitting 46.

The attachment element 16 thus provides the receiving space 19 for the jet regulator, which is matched to the dimensions of the flow obstacles 5 and the splitter unit 2.

FIG. 3 furthermore shows that the flow obstacles 5 have, in their extent 20 away from the carrying structure 43, a decreasing cross section 21.

In each case two adjacent flow obstacles 5 form between them an intermediate space 22, which is designed to be open to the outside. This produces a U-shaped basic shape of the two flow obstacles 5 together with a section of the carrying structure 43.

By comparing FIGS. 6 and 7, it is clear that the flow obstacles 5 are aligned parallel to one another.

The splitter unit 2 has a perforated plate 25 with an arrangement of sleeve-type holes 49.

This perforated plate 25 can be formed for example using an injection molding tool having projections arranged at the positions of the holes 49, wherein this injection molding tool can be removable counter to the main flow direction 4 for demolding purposes.

When the water passing through emerges into the mixing chamber 3, the sleeve-type holes 49 cause negative pressure, which can be used to suck off air via aeration windows 39.

This air/water mixture is mixed in the mixing space 3 into a water jet which is enriched with air and can exit in the form of a homogeneous jet through the outlet structure 9.

FIG. 7 shows the layers of the tool separation planes 27, 28, 29 which are present for the manufacturing of the jet regulator 1.

Here, a first injection molding tool is moved from above toward the tool separation plane 28 in order to form the splitter unit 2.

A second injection molding tool can be moved from below toward the tool separation plane 29 in order to form the outlet structure 9.

A third and fourth injection molding tool are moved laterally toward the tool separation plane 27 in order to form the carrying structure 43 and the flow obstacles 5. It is of benefit here during demolding that the flow obstacles 5 have cross sections 21 that decrease toward the outside and are also aligned parallel to one another.

A circumferential side wall 30 is formed at the splitter unit 2 on the inflow side, the side wall 30 imparting a cup shape to the inflow side. This supports the collection of the water flowing in at the holes 49.

In particular FIG. 7 shows that the flow obstacles 5 are arranged in four groups 31, which follow one another in the main flow direction 4.

It is clear in FIG. 6 that flow obstacles 5 within a group 31 have consistent cross sections.

By contrast, the flow obstacles 5 between the groups 31 have cross sections that differ at least in part.

By comparing FIGS. 6 and 7, it becomes clear that flow obstacles 5 which follow one another in the main flow direction 4 have matching lengths 32, with the result that a substantially cylindrical envelope is obtained.

Formed on the lower side or outflow side of the splitter unit 2 is a circumferential contact surface 33, which rests on the attachment element 16 during use and is axially fixed thereto, for example by a snap or pressure connection, cf. FIG. 3.

The splitter unit 2 has on the inflow side in the perforated region 34, which includes the holes 49, an arrangement of contact elements 35, which hold a seal ring 36 and align it in terms of its position.

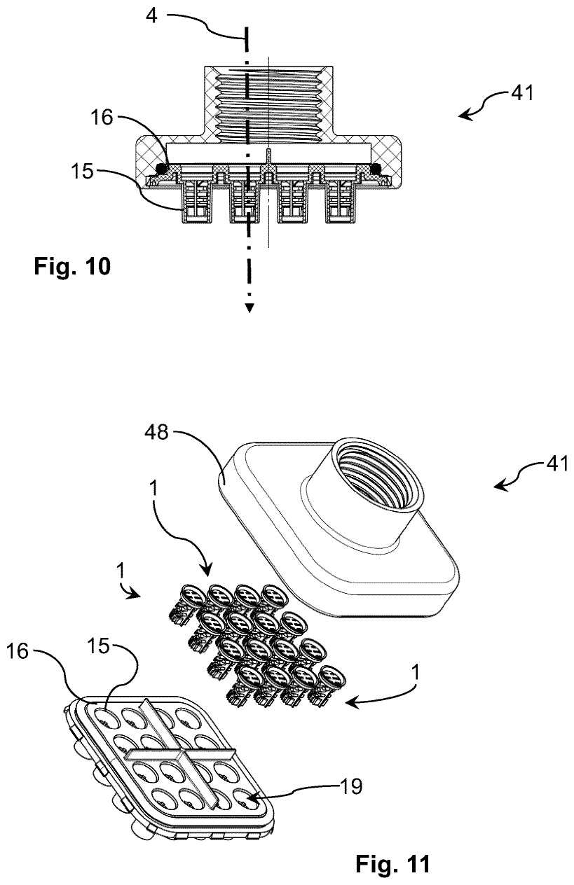

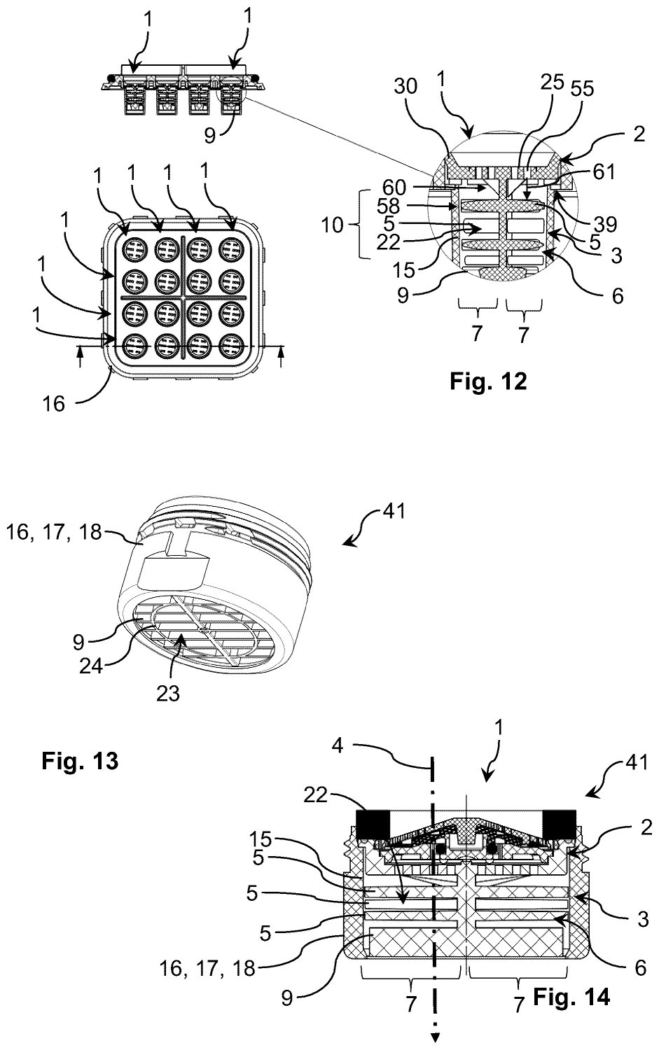

FIGS. 10 to 12 show a further exemplary embodiment according to the invention of a sanitary outlet unit 41.

The exemplary embodiment differs from the preceding exemplary embodiment in that the attachment element 16 has a plurality of receiving spaces 19 for one jet regulator 1 in each case.

The statements made regarding the preceding exemplary embodiment correspondingly apply to the jet regulator 1.

The attachment element 16 in this exemplary embodiment, however, is not configured for being screwed into a conventional water drain of a fitting 46, but a separate housing 48 is provided, which can be screwed to a fitting 46 or the like.

Aeration windows 39 are formed in the attachment element 16, which are assigned in each case to a jet regulator 1 and interact therewith.

FIGS. 13 to 19 show a further exemplary embodiment according to the invention of a sanitary outlet unit 41.

The explanations relating to the preceding exemplary embodiments apply accordingly here.

The exemplary embodiment differs from the preceding exemplary embodiments in that the outlet structure has completely bounded holes 23, which in the present case are in the form of slits.

The complete bounding is achieved here by a ring 24.

The exemplary embodiment according to FIGS. 13 to 18 additionally differs from the preceding exemplary embodiments in that reinforcement ribs 37 are formed on a side of the splitter unit 2 facing away from the flow.

These reinforcement ribs 37 describe, in the circumferential direction, a contour which corresponds to the contour of the free ends of the flow obstacles 5.

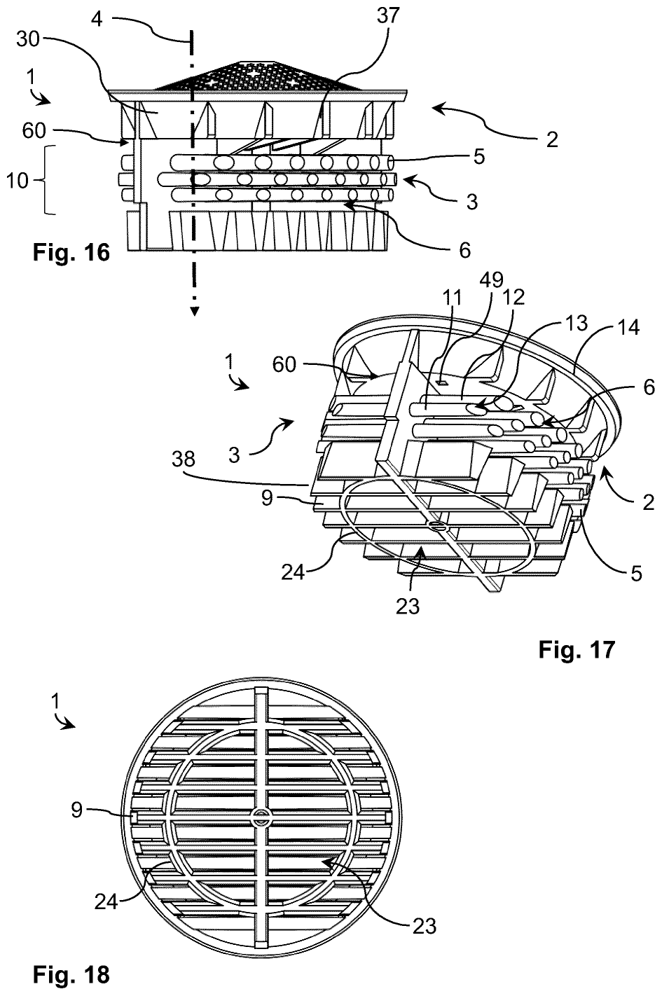

Consequently, the jet regulator 1 according to FIGS. 16 to 18 can be placed into the interior space 40 of the sleeve-shaped attachment element 16. This interior space 40 is substantially cylindrical and forms the receiving space 19 for the jet regulator 1, which has already been described.

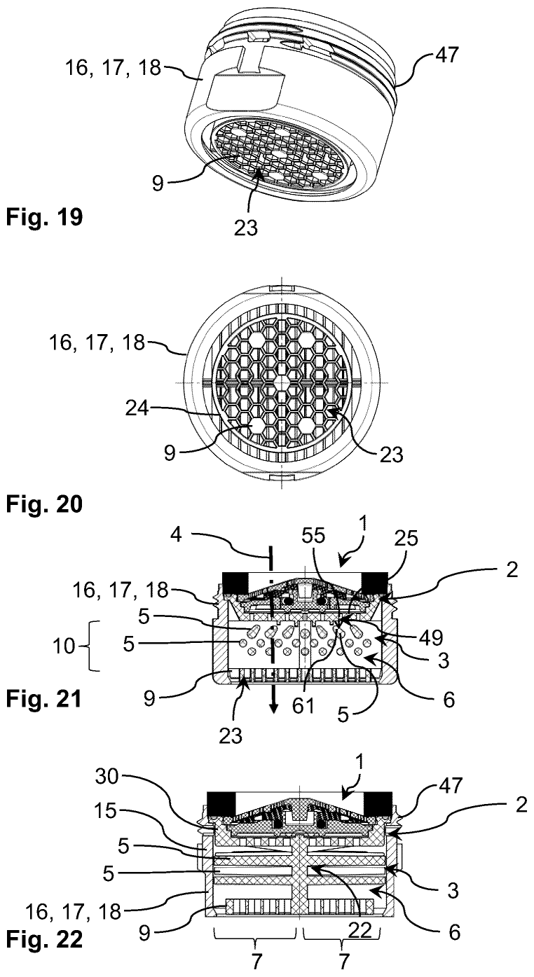

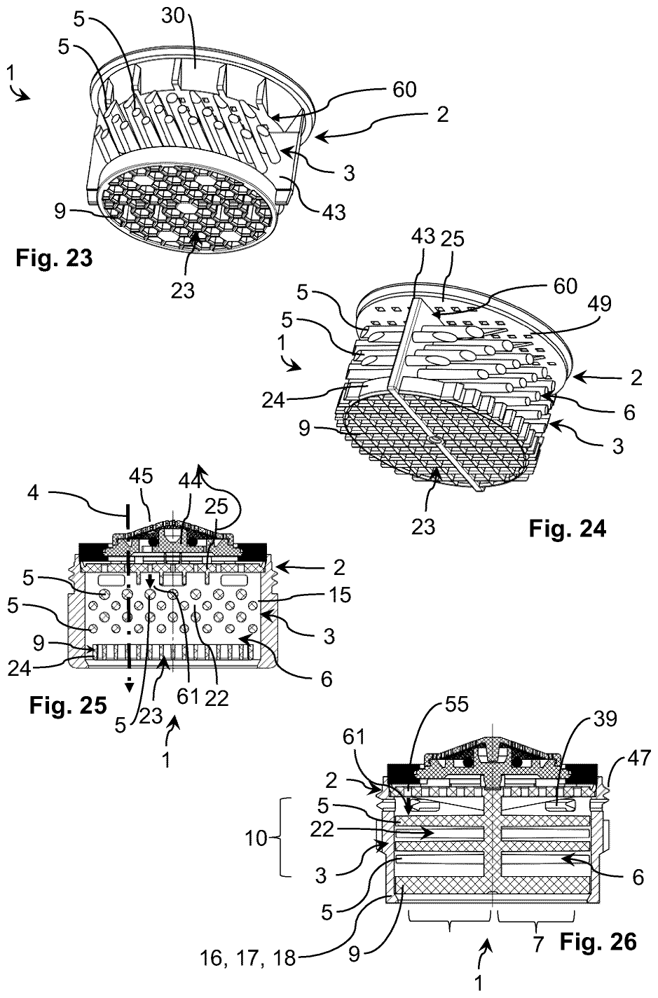

FIGS. 19 to 23 show a further exemplary embodiment according to the invention of a sanitary outlet unit 41.

The statements made regarding the preceding exemplary embodiments apply again correspondingly.

The exemplary embodiment differs from the preceding exemplary embodiments in that the outlet structure 9 is formed from a multiplicity of hexagonal holes 23.

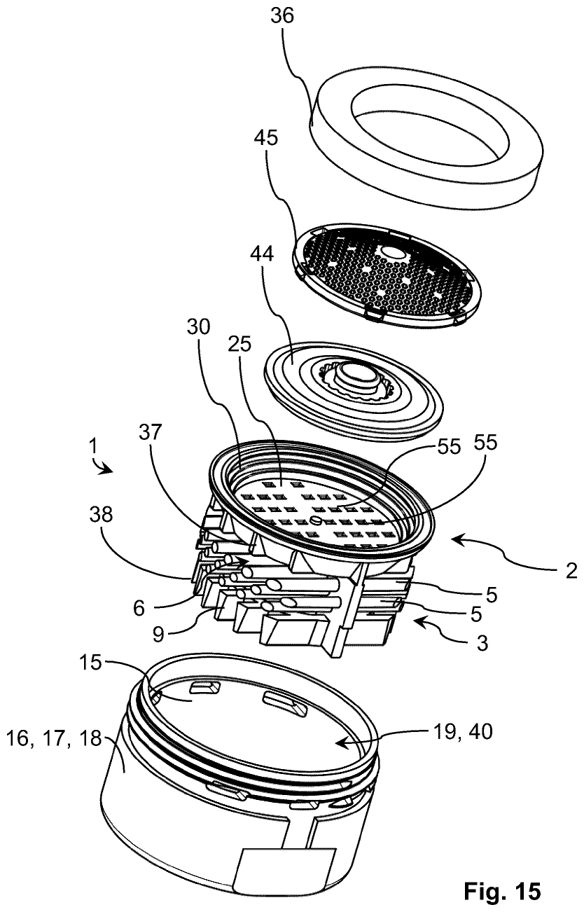

FIG. 15 also shows that the sanitary outlet unit 1 has a flow regulator 44 and an attachment screen 45, which are placeable into the cup-shaped splitter unit 2. This can be the case in all jet regulators 1 shown.

FIGS. 24 to 26 show a further exemplary embodiment according to the invention of a sanitary outlet unit 41.

The statements made regarding the preceding exemplary embodiments apply again correspondingly.

The exemplary embodiment differs from the remaining exemplary embodiments in that an outlet structure 9 with a rectangular grid is formed.

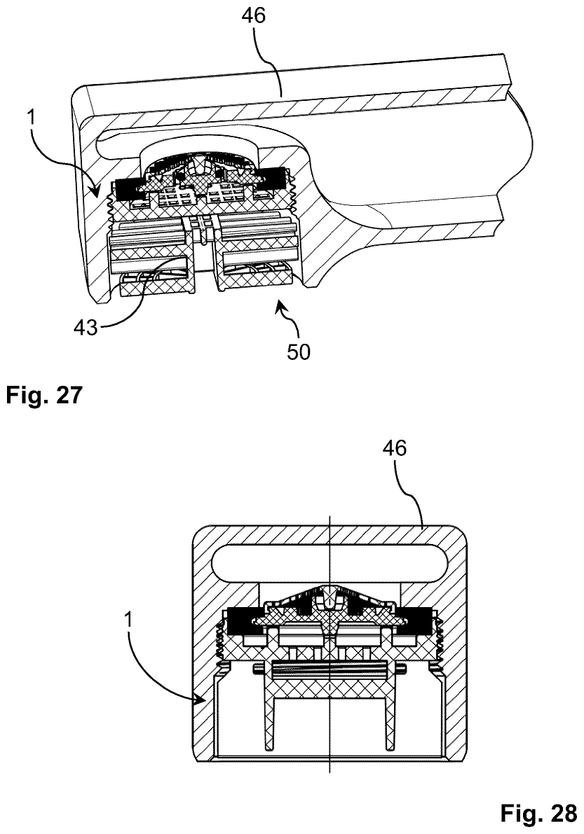

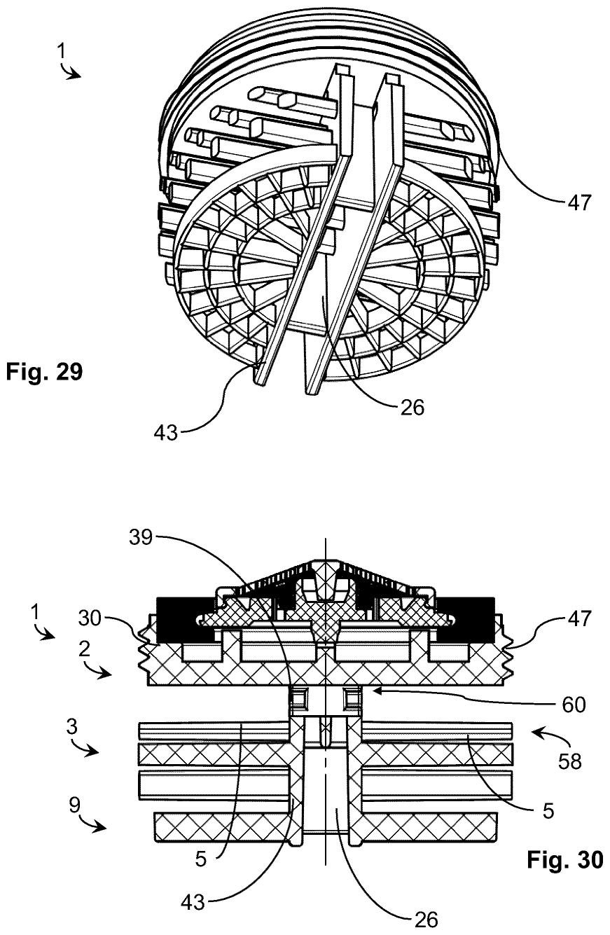

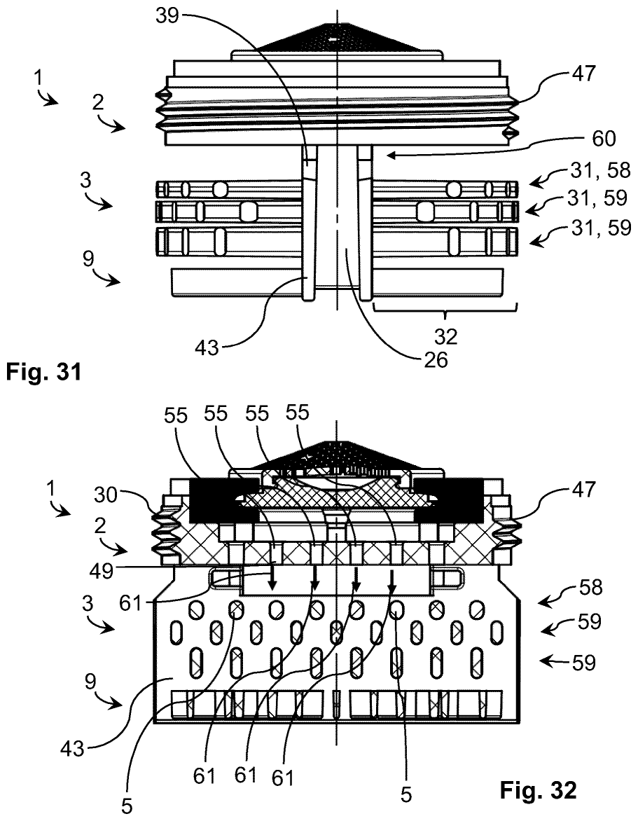

FIGS. 27 to 32 show a further exemplary embodiment according to the invention of a jet regulator 1.

Here, FIGS. 27 and 28 show that the jet regulator 1 may be screwed directly, that is to say without attachment element, into the water outlet 50 of a fitting 46.

For this purpose, the jet regulator 1 has a thread 47 at the height of the splitter unit 2.

The exemplary embodiment according to FIGS. 27 to 32 additionally differs in that the carrying structure 43 has a double wall and forms an aeration channel 26 in the interior.

This aeration channel issues via the aeration windows 39 into the mixing space 43 just below the splitter unit 2, with the result that the air can be sucked in in the manner described.

The aeration channel 26 is formed here such that it can additionally also serve as a tool contact point for screw-connecting the jet regulator 1.

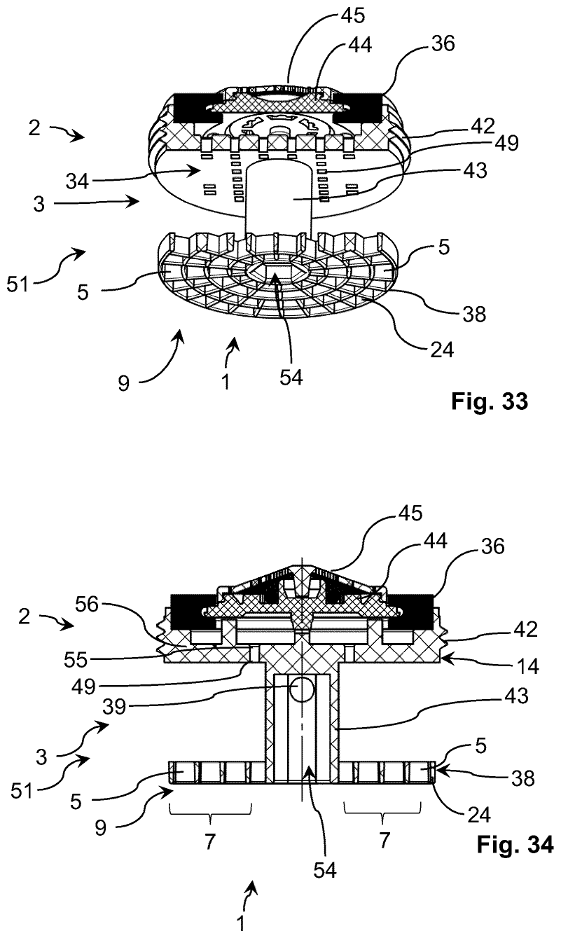

FIG. 33 shows a further exemplary embodiment according to the invention. Components and functional units which are similar or identical functionally and/or structurally to the preceding exemplary embodiments are denoted by the same reference signs and not separately described again. The statements made relating to FIGS. 1 to 32 therefore correspondingly apply to FIG. 33.

The exemplary embodiment according to FIG. 33 differs from the preceding exemplary embodiments in that the carrying structure 43 is in the form of a pin.

The flow obstacles 5 are molded in this case to the carrying structure 43 at a downstream end 51 of the mixing space 3.

The flow obstacles 5 form an outlet structure 9 which delimits the mixing space 3, which can otherwise be free of flow obstacles.

A tool contact point 54, such as a hexagon socket, is formed at the carrying structure 43 such that the former is accessible from the outside in order to be able to screw the jet regulator 1.

FIG. 34 shows a further jet regulator 1, which is a variant of FIG. 33. In this jet regulator 1, the carrying structure 43 is designed to be hollow inside.

Thus, an aeration channel 26 is formed. An aeration window 39 can be formed so that air can be guided into the mixing space 3.

The tool contact point 54, which can also be present here, may extend over some of or, as is shown here, over practically the entire axial length of the carrying structure 43.

In further exemplary embodiments, the aeration window 39 is closed.

The Figures show that due to the connection of the carrying structure 43 to the splitter unit 2, the flow obstacles 5 are forcibly aligned with positions of holes 49 in the splitter unit for water passing through.

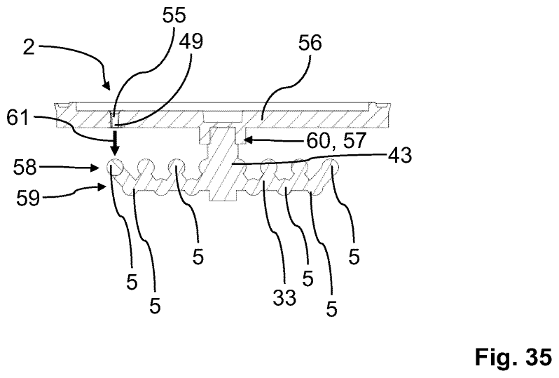

A reproducible and automatic alignment of the holes 49, from which the individual jets emerge in an outflow direction 61 (cf. FIG. 35) of the splitter unit 2, relative to an orientation of the flow obstacles 5 is thus achieved.

The forced alignment eliminates the degree of freedom of the rotation about a longitudinal axis which normally comes about when insert parts are used as flow obstacles.

The splitter unit 2 is designed here as a splitter plate 56 or a perforated plate 25. This results in a planar arrangement of the holes 49 transversely to the longitudinal axis.

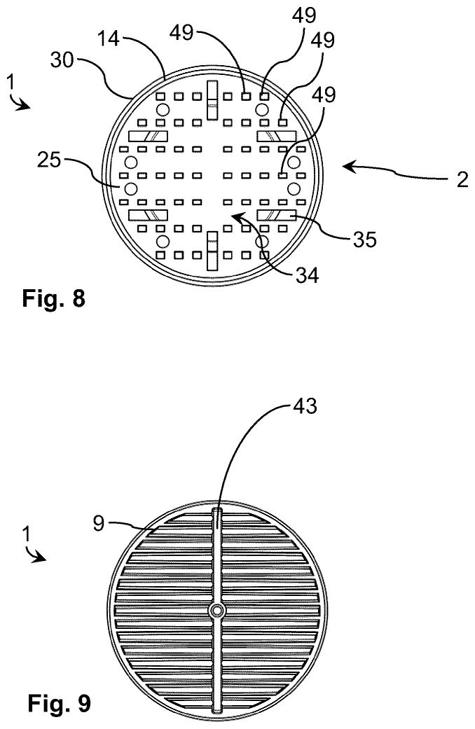

It is clear from the examples that the arrangement of the holes 49 is congruent with a shape of the flow obstacles 5, cf. FIGS. 8 and 9, for example. The holes 49 can thus be easily covered by downstream flow obstacles 5.

The mentioned holes 49 can be designed in each case as an exit of splitter nozzles 55 (cf. FIG. 35) of the splitter unit 2. Thus, outflow directions 61 of the individual jets are prescribed in a simple manner, as a result of which these individual jets are incident centrally on the respective downstream flow obstacle 5. The effect of this is optimal atomization and mixing with air.

One flow obstacle 5 is forcibly aligned with each hole 49 of the splitter unit 2 in a manner such that the water passing through the hole 40 is centrally incident on the flow obstacle 5. Deep (direct) penetration of the emerging individual jets into the mixing space 4 is thus avoidable.

It is particularly favorable if the flow obstacle 5 is arranged in an uppermost level 58 of a stack arrangement of a plurality of levels 58, 59 of flow obstacles 5. The flow obstacle 5 can thus be arranged particularly closely behind the hole 49 or at the splitter unit 5.

The flow obstacles 5 are aligned parallel to one another within one level 58, 59. The holes 49 are arranged in corresponding rows, which correspond to the flow obstacles or match them.

At least one hole 49 of the splitter unit 5 exists for each flow obstacle 5 in an uppermost level 58, with the water passing through it being centrally incident on the flow obstacle 5. In fact, there are a plurality of such holes 49 for each flow obstacle 5.

In FIGS. 1 to 34, the carrying structure 43 is molded in one piece to the splitter unit 5 on the outflow side.

In FIG. 35, the carrying structure 43 is connected to the splitter unit 5 via a non-releasable connection 60, for example a snap connection.

The connection has a symmetry-breaking interface 57 (by way of example having four edges), by way of which a forced alignment is defined. A form-fitting prescribed forced alignment is realized in this way.

It is thus proposed to form in a jet regulator 1, on the outflow side of a splitter unit 2, a plate-shaped carrying structure 43, from which flow obstacles 5 project on both sides into a mixing space 3.

### LIST OF REFERENCE NUMBERS

1 Jet regulator
2 Splitter unit
3 Mixing space
4 Main flow direction
5 Flow obstacle
6 Interior of the jet regulator
7 Subspace
8 Lateral extent of the splitter unit
9 Outlet structure
10 Installation height of the mixing space
11 Ba
12 Free end of the flow obstacles
13 End face
14 Circumferential contour of the splitter unit
15 Inner wall
16 Attachment element
17 Screw sleeve
18 Mouthpiece
19 Receiving space of the attachment element
20 Extent of the flow obstacles
21 Cross section of the flow obstacles
22 Intermediate space
23 Holes in the outlet structure
24 Ring
25 Perforated plate
26 Aeration channel
27 Tool separation plane
28 Tool separation plane
29 Tool separation plane
30 Side wall at the splitter unit
31 Group
32 Length
33 Contact surface
34 Perforated region
35 Contact element
36 Seal ring
37 Reinforcement rib
38 Contour of the outlet structure
39 Aeration window
40 Interior space
41 Sanitary outlet unit
42 Thread
43 Carrying structure
44 Flow regulator
45 Attachment screen
46 Fitting
47 Thread
48 Housing
49 Hole
50 Water outlet
51 Downstream end of 3
52 Lateral end of 43
53 Center of 43
54 Tool contact point
55 Splitter nozzle
56 Splitter plate
57 Interface
58 (Upper) level
59 (Lower) level
60 Connection
61 Outflow direction

1. A jet regulator (1), comprising:
a splitter unit (2),
flow obstacles (5), which arranged downstream of the splitter unit (2) and extend transversely to a main flow direction (4), and
a carrying structure (43) formed downstream of the splitter unit (2), the carrying structure (43) divides the mixing space (3) into at least two subspaces (7), each of the at least two subspaces (7) has a number of the flow obstacles (5), and the flow obstacles (5) protrude from the carrying structure (43).

2. The jet regulator (1) according to claim 1, wherein due to a connection of the carrying structure (43) to the splitter unit (2), the flow obstacles (5) are forcibly aligned with positions of holes (49) in the splitter unit (2) for water passing through.

3. The jet regulator (1) as claimed in claim 2, wherein one of the flow obstacles (5) is forcibly aligned with in each case one of the holes (49) in the splitter unit (2), such that water passing through the hole (49) is incident on the flow obstacle (5).

4. The jet regulator (1) as claimed in claim 1, wherein the flow obstacles (5) are aligned parallel to one another at least within one level.

5. The jet regulator (1) as claimed in wherein at least one hole in the splitter unit (5) exists for each of the flow obstacles (5) in an uppermost level, with the water passing through the respective hole being incident on the respective flow obstacle (5) in the uppermost level.

6. The jet regulator (1) as claimed in claim 1, wherein the carrying structure (43) is molded the splitter unit (5).

6. (canceled)

2. (canceled)

3. (canceled)

4. (canceled)

5. (canceled)

6. (canceled)

7. The jet regulator (1) as claimed in claim 1, wherein the carrying structure (43) extends from the splitter unit (2) to an outlet structure (9), and the outlet structure (9) is connected to the carrying structure (43).

8. The jet regulator (1) as claimed in claim 1, wherein the flow obstacles (5) comprise bars (11) which extend parallel to one another.

9. The jet regulator (1) as claimed in claim 1, wherein the flow obstacles (5) each form a free end (12).

10. The jet regulator (1) as claimed in claim 1, wherein the flow obstacles (5) each have a front face (13), which follows a circumferential contour (14) of the splitter unit (2).

11. The jet regulator (1) as claimed in claim 1, wherein the carrying structure (43) extends from the splitter unit (2) to an outlet structure (9), and at least one of a circumferential contour (14) of the splitter unit (2) is round or a contour (14) of the outlet structure (9) is round.

12. The jet regulator (1) as claimed in claim 1, wherein at least one of a) the flow obstacles (5) at lateral ends (52) of the carrying structure (43) are shorter than at a center (53) of the carrying structure (43) or b) a length (32) of the flow obstacles (5) increases from the lateral end (52) of the carrying structure (43) to the center (53) of the carrying structure (43).

13. The jet regulator (1) as claimed in claim 1, wherein the flow obstacles (5) in an extent (20) thereof away from the carrying structure (43) have a non-increasing cross section (21).

14. The jet regulator (1) as claimed in claim 1, wherein in each case two adjacent ones of the flow obstacles (5) enclose an intermediate space (22) which is delimited in a U shape.

15. The jet regulator (1) as claimed in claim 1, wherein adjacent ones of the flow obstacles (5) are aligned parallel to one another.

16. The jet regulator (1) as claimed in claim 7, wherein the outlet structure (9) has completely bounded holes (23).

17. The jet regulator (1) as claimed in claim 7, wherein the outlet structure (9) has at least one circumferential ring (24).

18. The jet regulator (1) as claimed in claim 1, wherein the splitter unit (2) comprises a perforated plate (25).

19. The jet regulator (1) as claimed in claim 1, further comprising an aeration channel (26) leading from an outside to the splitter unit (2) formed in the carrying structure (43).

20. The jet regulator (1) as claimed in claim 19, further comprising a tool contact point (54) for screw-connecting the jet regulator (1) formed at at least one of the aeration channel (26) or an outlet structure (9) downstream of the carrying structure (43).

21. The jet regulator (1) as claimed in claim 1, further comprising a tool separation plane (27, 28, 29) that extends along the carrying structure (43).

22. The jet regulator (1) as claimed in claim 1, further comprising a tool separation plane (27, 28, 29) that extends along at least one of the splitter unit (2) or an outlet structure (9).

23. The jet regulator (1) as claimed in claim 1, wherein the splitter unit (2) at least one of forms a side wall (30) on an inflow side or is cup-shaped.

24. The jet regulator (1) as claimed in claim 1, wherein the flow obstacles (5) are arranged in at least two groups (31) lying one above the other in the main flow direction (4).

25. The jet regulator (1) as claimed in claim 1, wherein ones of the flow obstacles (5) which follow one another in the main flow direction (4) have matching lengths (32).

26. The jet regulator (1) as claimed in claim 1, wherein a circumferential contact surface (33) is formed on the splitter unit (2), and delimits the flow obstacles (5) in a lateral direction.

27. The jet regulator (1) as claimed in claim 26, wherein the splitter unit (2) has contact elements (35) on an inflow side in a perforated region (34), and the contact elements (35) at least one of contact with or laterally align a seal ring (36).

28. The jet regulator (1) as claimed in claim 26, wherein the splitter unit (2) includes outside reinforcement ribs (37), and free ends of the reinforcement ribs (37) follow a contour (38) described by the contact surface (33).

29. The jet regulator (1) as claimed in claim 1, wherein the carrying structure (43) is molded to the splitter unit (2).

30. A sanitary outlet arrangement, comprising the jet regulator (1) as claimed in claim 1 and an attachment element (16) receiving the jet regulator (1), wherein free ends of the flow obstacles (12) terminate at an inner wall (15) of the attachment element (16).

31. The sanitary outlet arrangement as claimed in claim 30, wherein at least one of a) the attachment element (16) comprises a sleeve, or the attachment element (16) grips the jet regulator (1) by the splitter unit (2).

32. The sanitary outlet arrangement as claimed in claim 30, wherein the attachment element (16) has at least two receptacles for receiving two of the jet regulators (1).

33. The sanitary outlet arrangement as claimed in claim 30, wherein the attachment element (16) has at least one aeration window (39).

34. The sanitary outlet arrangement as claimed in claim 30, wherein the outlet structure (9) is arranged at a distance from the attachment element (16).

35. The jet regulator (1) as claimed in claim 2, wherein the carrying structure (43) is connected via a connection, which defines the forced alignment.

36. The jet regulator (1) as claimed in claim 1, wherein at least one of a) the mixing space (3) is open to outside or b) the flow obstacles (5) are molded to the carrying structure (43).

37. A jet regulator (1), comprising:
a splitter unit (2),
flow obstacles (5), which arranged downstream of the splitter unit (2) and extend transversely to a main flow direction (4), and
a carrying structure (43) formed downstream of the splitter unit (2),
wherein the flow obstacles (5) form an outlet structure (9) delimiting the mixing space, the mixing space (3) is open to outside, and the flow obstacles (5) are molded to the carrying structure (43).

38. The jet regulator (1) as claimed in claim 37, wherein the mixing space (3) is formed to be free of flow obstacles.

39. The jet regulator (1) as claimed in claim 37, wherein the carrying structure (43) is at least one of plate-shaped or designed to be watertight at least in a region of the flow obstacles, or wherein the carrying structure (43) is pin-shaped.

40. The jet regulator (1) as claimed in claim 37, wherein the carrying structure (43) extends over a lateral extent (8) of the splitter unit (2).
